(19) United States
(12) Patent Application Publication
(10) Pub. No.: US 2017/0030305 A1
(43) Pub. Date: Feb. 2, 2017

(54) EGR SYSTEM FOR SUPERCHARGING ENGINE

(71) Applicant: TOYOTA JIDOSHA KABUSHIKI KAISHA, Toyota-shi, Aichi-ken (JP)

(72) Inventor: Satoshi SUGIYAMA, Mishima-shi, Shizuoka-ken (JP)

(73) Assignee: TOYOTA JIDOSHA KABUSHIKI KAISHA, Toyota-shi, Aichi-ken (JP)

(21) Appl. No.: 15/105,870

(22) PCT Filed: Oct. 30, 2014
(86) PCT No.: PCT/JP2014/079514

§ 371 Date: Jun. 17, 2016

(30) Foreign Application Priority Data
Dec. 20, 2013 (JP) 2013-264132

(51) Int. Cl. F02M 26/04; F02D 41/00; F02D 21/08; F02D 23/00; F02B 37/12; F02B 47/08

(52) U.S. Cl. CPC F02M 26/04; F02B 37/12; F02B 47/08; F02D 21/08; F02D 23/00; F02D 41/0007; F02D 41/0047

(57) ABSTRACT

In an EGR system that introduces an EGR gas to a vicinity of an inlet of a compressor in an intake passage, prevention of erosion of an impeller by condensed water generated in an EGR passage, and restraint of pressure loss of intake air are made compatible. An introduction port for an EGR gas formed in a wall surface of the intake passage in a vicinity of the inlet of the compressor and an exhaust passage are connected by the EGR passage. The EGR passage is provided with an EGR valve, and an exhaust throttle valve is provided downstream of a position where the EGR passage is connected in the exhaust passage. By a control device that controls the EGR valve and the exhaust throttle valve, respective opening degrees of the EGR valve and the exhaust throttle valve are controlled in accordance with a flow rate of fresh air that flows to the compressor, and a velocity of the EGR gas that flows out into the intake passage from the introduction port for the EGR gas is changed so that the EGR gas flows toward a center portion of the impeller of the compressor.

### TECHNICAL FIELD

The present invention relates to an EGR system for a supercharging engine that is configured to introduce an EGR gas to a vicinity of an inlet of a compressor in an intake passage.

### BACKGROUND ART

A so-called LPL-EGR system for use in a supercharging engine is an EGR system that is configured to introduce an exhaust gas that is taken out from a downstream side of a turbine in an exhaust passage to an upstream side of a compressor in an intake passage. When an outdoor temperature is low and an engine cooling water temperature is low, and when the efficiency of an EGR cooler is so high that the outlet temperature of the EGR cooler is low, the wall surface temperature of the EGR passage is lower than the dew point of the EGR gas, whereby condensed water is generated. If an EGR gas is introduced into the intake passage in such cases, the condensed water in the EGR passage flows into the intake passage together with the EGR gas, and the condensed water collides with the impeller of the compressor, whereby erosion occurs to the impeller. With respect to the problem like this, in the prior art disclosed in Japanese Patent Laid-Open No. 2009-024692, the distal end of the EGR pipe is extended to the inside of the intake passage to provide an introduction port for an EGR gas in a central portion of the intake passage, and thereby the EGR gas is caused to flow to a center portion of the impeller with a low circumferential speed instead of the outer circumferential part of the impeller with a high circumferential speed.

### CITATION LIST

### Patent Literature

Patent Literature 1: Japanese Patent Laid-Open No. 2009-024692

### SUMMARY OF THE INVENTION

However, the EGR pipe which protrudes to the inside of the intake passage becomes a resistance to air that flows in the intake passage. Therefore, there is the fear that the engine performance is reduced by increase in pressure loss of the intake air.

The present invention is made in the light of the aforementioned problem, and has an object to make prevention of erosion of an impeller by condensed water generated in an EGR passage and restriction of pressure loss of intake air compatible, in an EGR system for a supercharging engine configured to introduce an EGR gas to a vicinity of an inlet of a compressor in an intake passage.

In order to attain the above described object, an EGR system for a supercharging engine according to the present invention is configured as follows.

The present EGR system includes an introduction port for introducing an EGR gas into an intake passage, and the introduction port is formed in a wall surface of the intake passage in a vicinity of an inlet of a compressor. The introduction port for the EGR gas is connected to an exhaust passage by an EGR passage. The present EGR system includes an EGR valve, an exhaust throttle valve, and a control device that controls the EGR valve and the exhaust throttle valve. Note that the exhaust throttle valve can be replaced with an intake throttle valve in the intake path. The EGR valve is provided in the EGR passage, and the exhaust throttle valve is provided downstream of a position where the EGR passage is connected in the exhaust passage. The control device includes a control program for changing a velocity of the EGR gas that flows out into the intake passage from the introduction port for EGR in accordance with a flow rate of fresh air that flows to the compressor so that the EGR gas flows toward a center portion of an impeller of the compressor. The control program is configured to control respective opening degrees of the EGR valve and the exhaust throttle valve in accordance with the flow rate of the fresh air that flows to the compressor.

In one mode of the present EGR system, the EGR valve is provided at a position apart from the introduction port for the EGR gas. The control program includes a step of calculating a target flow velocity of the EGR gas based on a measured value or an estimated value of the flow rate of the fresh air that flows to the compressor, a step of calculating a target volume flow rate of the EGR gas based on the target flow velocity of the EGR gas, and a step of determining the respective opening degrees of the EGR valve and the exhaust throttle valve based on the target volume flow rate of the EGR gas.

In another mode of the present EGR system, the EGR valve is a valve that is provided in the introduction port for the EGR gas and makes an introduction port area variable. The control program includes a step of calculating a target flow velocity of the EGR gas based on a measured value or an estimated value of the flow rate of the fresh air that flows to the compressor, a step of calculating a target volume flow rate of the EGR gas based on the measured value or the estimated value of the flow rate of the fresh air, and a target EGR rate, a step of determining the opening degree of the EGR valve based on the target flow velocity and the target volume flow rate of the EGR gas, and a step of determining the opening degree of the exhaust throttle valve based on the opening degree of the EGR valve and the target volume flow rate of the EGR gas.

In still another mode of the present EGR system, the EGR valve is a butterfly valve provided in the introduction port for the EGR gas. More preferably, a surface at a side of the EGR passage of the butterfly valve is a concave surface. The control program includes a step of calculating a target flow velocity and a target outflow angle of the EGR gas based on a measured value or an estimated value of the flow rate of the fresh air that flows to the compressor, a step of determining the opening degree of the EGR valve based on the target outflow angle of the EGR gas, a step of calculating a target volume flow rate of the EGR gas based on the target flow velocity of the EGR gas and the opening degree of the EGR valve, and a step of determining the opening degree of the exhaust throttle valve based on the opening degree of the EGR valve and the target volume flow rate of the EGR gas.

According to the present invention, the velocity of the EGR gas that flows out from the introduction port is changed in accordance with the flow rate of fresh air, whereby the EGR gas can be caused to flow toward the center portion of the impeller without extending the EGR pipe to the inside of the intake passage and guiding the EGR gas to the center of the intake passage. Therefore, prevention of erosion of the impeller by condensed water generated in the EGR passage, and restraint of the pressure loss of the intake air can be made compatible. In addition, according to the present invention, the EGR valve and the exhaust throttle valve are used in combination as means for changing the velocity of the EGR gas, and therefore, the control range of the velocity of the EGR gas can be enlarged. Thereby, the exit velocity necessary to flow toward the center portion of the impeller can be given to the EGR gas irrespective to the operation state of the engine.

### BRIEF DESCRIPTION OF THE DRAWINGS

FIG. 1 is a diagram showing an entire configuration of a supercharging engine to which an EGR system according to a first embodiment of the present invention is applied;

FIG. 2 is a sectional view showing a configuration of a mixer of the EGR system according to the first embodiment of the present invention;

FIG. 3 is a sectional view showing a configuration in a vicinity of an introduction port for an EGR gas and an exit velocity of the EGR gas from the introduction port, of the EGR system according to the first embodiment of the present invention;

FIG. 4 is a diagram showing a flow rate characteristic of an EGR valve;

FIG. 5 is a flowchart showing a routine for control of an EGR valve and an exhaust throttle valve that is executed by a control device in the EGR system according to the first embodiment of the present invention;

FIG. 6 is a diagram showing an entire configuration of a supercharging engine to which an EGR system according to a second embodiment of the present invention is applied;

FIG. 7 is a sectional view showing a configuration in a vicinity of an introduction port for an EGR gas and an exit velocity of the EGR gas from the introduction port, of the EGR system according to the second embodiment of the present invention;

FIG. 8 is a flowchart showing a routine for control of an EGR valve and an exhaust throttle valve that are executed by a control device in the EGR system according to the second embodiment of the present invention;

FIG. 9 is a sectional view showing a configuration in a vicinity of an introduction port for an EGR gas and an exit velocity of the EGR gas from the introduction port, of the EGR system according to a third embodiment of the present invention;

FIG. 10 is a view showing a shape of an EGR valve of the EGR system according to the third embodiment of the present invention; and

FIG. 11 is a flowchart showing a routine for control of the EGR valve and an exhaust throttle valve that is executed by a control device in the EGR system according to the third embodiment of the present invention.

### DESCRIPTION OF EMBODIMENTS

### First Embodiment

Hereinafter, a first embodiment of the present invention will be described with reference to the drawings.

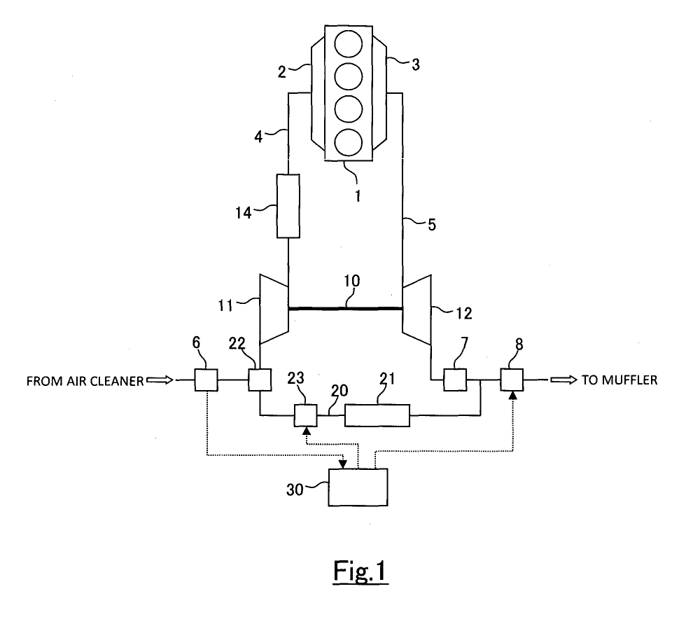

FIG. 1 is a diagram showing an entire configuration of a supercharging engine to which an EGR system according to the first embodiment of the present invention is applied. In the present embodiment, the type of supercharging engine is not limited. The supercharging engine may be a spark ignition type engine, or may be a compression ignition type engine. An engine main body 1 of the supercharging engine includes a plurality of cylinders. While FIG. 1 shows an example in which four cylinders are disposed in series, the number of cylinders and arrangement of the cylinders are not limited.

An intake manifold 2 is mounted to an intake side of the engine main body 1. Fresh air that is taken into an intake passage 4 from an air cleaner not illustrated is supplied to the respective cylinders of the engine main body 1 via the intake manifold 2. An airflow meter 6 that outputs a signal corresponding to a flow rate (mass flow rate) of the fresh air which is taken into the intake passage 4 is provided downstream of the air cleaner in the intake passage 4. A centrifugal compressor 11 of a supercharger 10 is provided downstream of the airflow meter 6 in the intake passage 4.

An exhaust manifold 3 is mounted to an exhaust side of the engine main body 1. An exhaust gas that is discharged to the exhaust manifold 3 from the respective cylinders of the engine main body 1 is released into the atmosphere via an exhaust passage 5. A turbine 12 of the supercharger 10 is provided at the exhaust passage 5. A catalyst 7 for use in purification of the exhaust gas is provided downstream of the turbine 12 in the exhaust passage 5.

The EGR system according to the present embodiment includes an EGR passage 20 that connects a downstream side from the catalyst 7 in the exhaust passage 5 and an upstream side from the compressor 11 in the intake passage 4. The EGR passage 20 is connected to a vicinity of an inlet of the compressor 11. An exhaust throttle valve 8 is provided downstream of a position of the exhaust passage 5 where the EGR passage 20 is connected. The exhaust throttle valve 8 is a butterfly valve, for example. The exhaust throttle valve 8 is one of elements that configure the present EGR system. The EGR passage 20 is provided with an EGR cooler 21 and an EGR valve 23 in sequence from an exhaust side. The EGR valve 23 is provided at a position apart from a connecting portion of the EGR passage 20 and the intake passage 4. The EGR valve 23 may be a butterfly valve or a poppet valve. The EGR valve 23 as well as the exhaust throttle valve 8 is controlled by a control device 30.

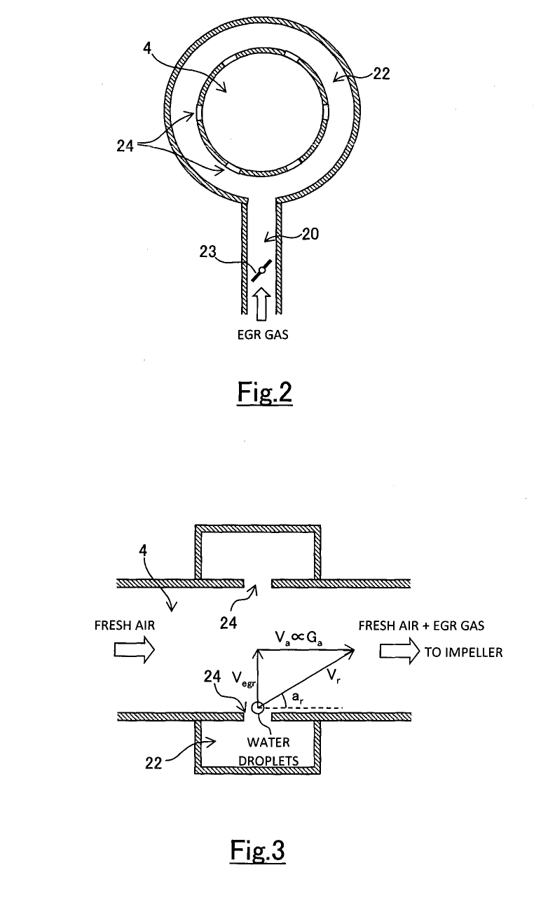

A mixer 22 is provided at the connecting portion of the EGR passage 20 and the intake passage 4. A structure of the mixer 22 is shown in detail in FIG. 2. The mixer 22 is formed into a cylindrical shape to surround the intake passage 4, and has introduction ports 24 for an EGR gas that communicate with an inside of the intake passage 4 at a plurality of spots in an inner circumferential side. The EGR gas that is supplied to the mixer 22 from the EGR passage 20 through the EGR valve 23 is introduced to the inside of the intake passage 4 via the introduction ports 24 from the plurality of spots in a circumferential direction of the intake passage 4.

FIG. 3 is a sectional view showing a configuration in vicinities of the introduction ports 24 for an EGR gas of the EGR system according to the present embodiment. As shown in FIG. 3, the EGR gas which is introduced from the introduction ports 24 merges into fresh air that flows from an upstream side of the intake passage 4, and a mixture gas of the fresh air and the EGR gas flows to an impeller of the compressor. At this time, condensed water that is generated in the EGR passage 20 forms water droplets and flows out into the intake passage 4 from the introduction ports 24 together with the EGR gas. In FIG. 3, a relation of a flow rate of the fresh air, a flow velocity of the EGR gas that flows out of the introduction ports 24, a traveling direction in the intake passage 4 of the water droplets contained in the EGR gas at this time is expressed by a vector diagram. In FIG. 3, Gₐ represents the flow rate (mass flow rate) of fresh air, Vₐ represents a flow velocity of the fresh air, V_{egr} represents the flow velocity of the EGR gas, Vᵣ represents a velocity in the intake passage 4, of the water droplets contained in the EGR gas, and aᵣ represents a travel angle of the water droplets contained in the EGR gas, respectively.

The flow velocity of the fresh air can be deemed as proportional with the flow rate of the fresh air. The velocity of the water droplets in the intake passage 4 can be expressed by a relative velocity of the velocity of the fresh air and the velocity of the EGR gas. This is because while when movement of the water droplets as a liquid is calculated, inertia thereof needs to be taken into consideration, the water droplets contained in the EGR gas is microscopic, and therefore, the water droplets can be regarded as moving integrally with the EGR gas which is a gas. The velocity and the angle of the water droplets in the intake passage 4 are determined by the relation of the flow velocity of fresh air and the flow velocity of the EGR gas. Since the flow velocity of the fresh air is uniquely determined by the flow rate, the velocity and the angle of the water droplets in the intake passage 4 are controllable by changing the flow velocity of the EGR gas in accordance with the flow rate of the fresh air. Therefore, in order to prevent collision of the water droplets contained in the EGR gas and the impeller, the flow velocity of the EGR gas can be controlled so that the water droplets flow toward a center portion of the impeller, namely, the EGR gas flows toward the center portion of the impeller.

According to a configuration of the EGR system according to the present embodiment, the EGR gas flows out from the introduction ports 24 perpendicularly to a flow of the fresh air. Therefore, as for the velocity of the EGR gas that flows out from the introduction ports 24, an outflow angle is always constant and 90 degrees, and only the flow velocity (magnitude of velocity) changes. The flow velocity of the EGR gas that flows out from the introduction ports 24 is determined by a volume flow rate of the EGR gas that flows out and an opening area of the introduction ports 24. More specifically, a value that is obtained by dividing the volume flow rate of the EGR gas which is supplied to the mixer 22 from the EGR passage 20 by a total opening area of the plurality of introduction ports 24 that the mixer 22 has corresponds to the flow velocity (average flow velocity) of the EGR gas which flows out from each of the introduction ports 24. According to the configuration of the EGR system according to the present embodiment, the total opening area of all the introduction ports 24 is constant, and therefore, the flow velocity of the EGR gas can be controlled based on the volume flow rate of the EGR gas.

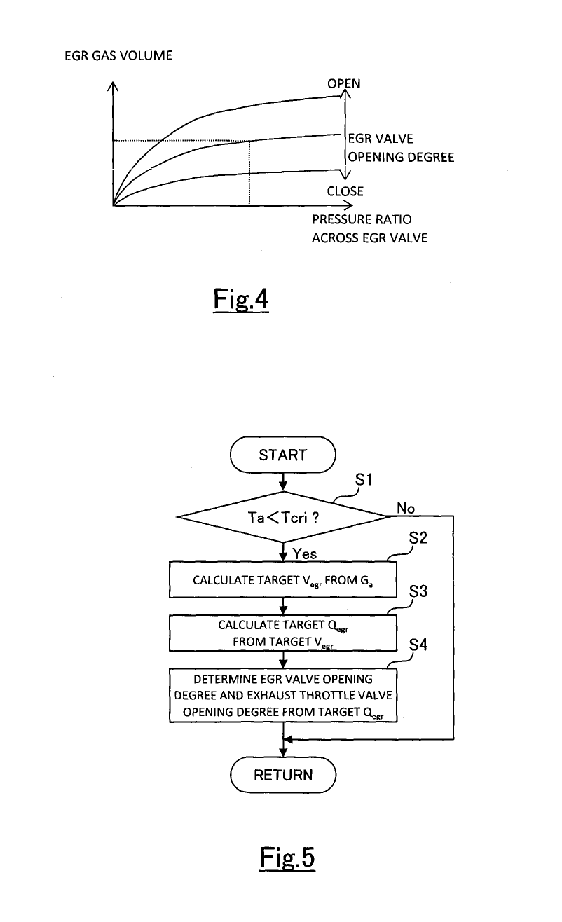

The volume flow rate of the EGR gas which is supplied to the mixer 22 from the EGR passage 20 is a volume flow rate of the EGR gas that passes through the EGR valve 23. FIG. 4 is a diagram showing a flow rate characteristic of an ordinary EGR valve. Since the EGR valve corresponds to a throttle section in a flow path, a volume flow rate of an EGR gas that passes through the EGR valve is determined by an opening degree of the EGR valve and a pressure ratio across the EGR valve (a ratio of pressure upstream of the EGR valve to pressure downstream of the EGR valve). In the case of the EGR system according to the present embodiment, pressure downstream of the EGR valve 23 is pressure upstream of the compressor 11 in the intake passage 4, and this is uniquely determined by the flow rate of fresh air. Meanwhile, pressure upstream of the EGR valve 23 is pressure upstream of the exhaust throttle valve 8 in the exhaust passage 5. Since the pressure upstream of the exhaust throttle valve 8 changes in accordance with an opening degree of the exhaust throttle valve 8, the pressure ratio across the EGR valve 23 can be indirectly controlled by controlling the exhaust throttle valve 8.

As is understood from the flow rate characteristic shown in FIG. 4, a range of the volume flow rate of the EGR gas that can be realized by changing only the opening degree of the EGR valve 23 is limited. Similarly, a range of the volume flow rate of the EGR gas that can be realized by changing only the pressure ratio across the EGR valve 23 is also limited. However, according to the configuration of the EGR system according to the present embodiment, since both of the opening degree of the EGR valve 23 and the pressure ratio across the EGR valve 23 can be independently changed by control of each of the EGR valve 23 and the exhaust throttle valve 8, the range of the volume flow rate of the EGR gas that can be realized is wide, and a desired volume flow rate can be realized. Namely, according to the configuration of the EGR system according to the present embodiment, the volume flow rate of the EGR gas is controlled by controlling each of the EGR valve 23 and the exhaust throttle valve 8, whereby the flow velocity of the EGR gas that flows out from the introduction ports 24 can be controlled.

In the EGR system according to the present embodiment, control of each of the EGR valve 23 and the exhaust throttle valve 8 is performed by the control device 30. FIG. 5 is a flowchart showing a routine that is executed by the control device 30 in the present embodiment. The routine is one of control programs included in the control device 30. The control program stored in a memory of the control device 30 is read and executed by a processor, and thereby a function as a “control device” according to the present invention is given to the control device 30. Hereinafter, the routine will be sequentially described.

In step S1, the control device 30 compares an atmospheric temperature (Ta) with a condensed water generation temperature (Tcri) that is set in advance. The atmospheric temperature is a temperature measured by an outdoor temperature sensor not illustrated, and is used as a substitute for a temperature in an upstream side from the compressor 11 in the intake passage 4. If a temperature in a vicinity of the introduction ports 24 of the intake passage 4 is the condensed water generation temperature or higher, water vapor that is contained in the EGR gas is not condensed in the intake passage 4. Further, even if the EGR gas contains condensed water that is generated in the EGR passage 20, the condensed water evaporates in the intake passage 4. Therefore, when the temperature is the condensed water generation temperature or higher, a problem of erosion of the impeller by condensed water does not arise, and therefore, the control device 30 ends the present routine.

When the atmospheric temperature is lower than the condensed water generation temperature, the control device 30 sequentially executes processing of each of steps S2, S3 and S4.

In step S2, the control device 30 calculates a target flow velocity (target V_{egr}) of the EGR gas based on a flow rate (Gₐ) of fresh air that is measured by the airflow meter 6. As shown in the vector diagram, the flow velocity of the EGR gas required to cause the EGR gas to flow to the center portion of the impeller of the compressor 11 is uniquely determined by the flow rate of fresh air. The control device 30 has a map that makes the flow velocity of the EGR gas correspond to the flow rate of fresh air, and determines the target flow velocity of the EGR gas by using the map.

In step S3, the control device 30 calculates a target volume flow rate (target Q_{egr}) of the EGR gas based on the target flow velocity of the EGR gas which is calculated in step S2. A value that is obtained by multiplying the total opening area of all the introduction ports 24 which the mixer 22 has by the target flow velocity corresponds to the target volume flow rate.

In step S4, the control device 30 determines respective opening degrees of the EGR valve 23 and the exhaust throttle valve 8 based on the target volume flow rate of the EGR gas calculated in step S3. As is understood from the flow rate characteristic of the EGR valve shown in FIG. 4, with respect to one EGR gas volume flow rate, a number of combinations of the opening degrees of the EGR valve 23 and the pressure ratios across the EGR valve 23 that can realize the EGR gas volume flow rate are present. Therefore, in the present embodiment, a constraint is given to the opening degree of the exhaust throttle valve 8 from the viewpoints of fuel efficiency and controllability of valves, and the combination of the opening degree of the EGR valve 23 and the opening degree of the exhaust throttle valve 8 that satisfies both the constraint and the target volume flow rate is searched for. If a plurality of combinations like this are present, the combination of the opening degree of the EGR valve 23 and the opening degree of the exhaust throttle valve 8 that achieves the highest fuel efficiency is selected.

By cooperatively controlling the EGR valve 23 and the exhaust throttle valve 8 in accordance with the above routine, the flow velocity of the EGR gas which flows out from the introduction ports 24 is changed in accordance with the flow rate of fresh air, and the EGR gas containing condensed water can be caused to flow toward the center portion of the impeller. Note that the method for determining the respective opening degrees of the EGR valve 23 and the exhaust throttle valve 8 based on the target volume flow rate of the EGR gas is not limited to the method described in step S4. For example, when the opening degree of the exhaust throttle valve 8 or the pressure upstream of the exhaust throttle valve 8 is determined from another request relating to the engine performance, the opening degree of the EGR valve 23 can be determined from the opening degree of the exhaust throttle valve 8 or the pressure upstream from the exhaust throttle valve 8 and the target volume flow rate.

### Second Embodiment

Next, a second embodiment of the present invention will be described with reference to the drawings.

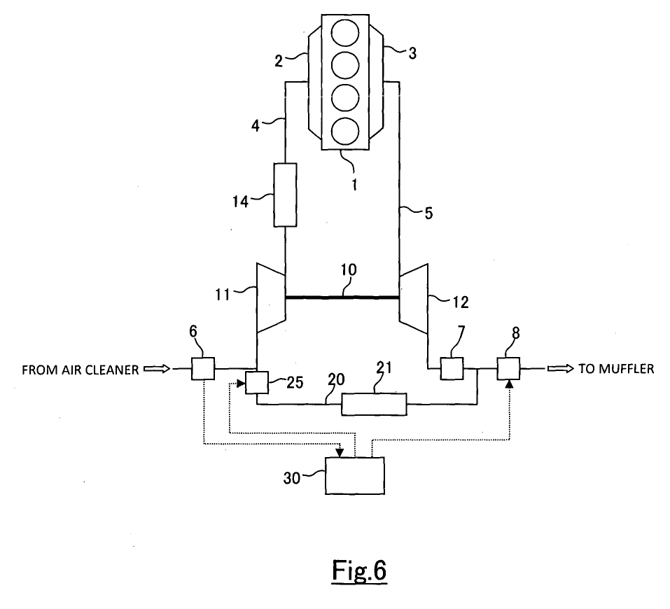

FIG. 6 is a diagram showing an entire configuration of a supercharging engine to which an EGR system according to the second embodiment of the present invention is applied. In FIG. 6, the same reference signs are assigned to the components or parts common to the supercharging engine shown in FIG. 1. Further, explanation thereof will be omitted.

In the EGR system according to the present embodiment, the EGR passage 20 is directly connected to the intake passage 4. An EGR valve 25 is provided at a connecting portion of EGR passage 20 and the intake passage 4. The EGR valve 25 of the present embodiment is a poppet valve with a variable lift amount. The EGR valve 25 as well as the exhaust throttle valve 8 is controlled by the control device 30.

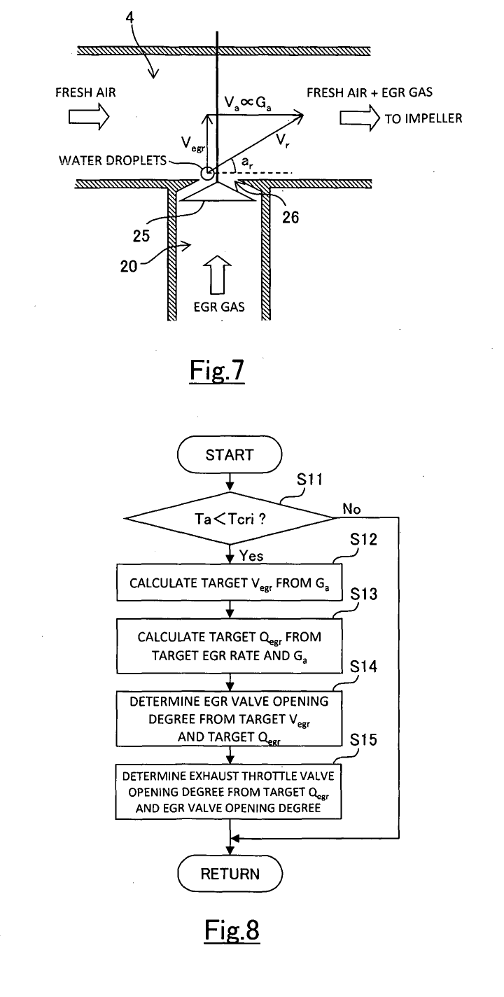

FIG. 7 is a sectional view showing a configuration of a vicinity of an introduction port 26 for an EGR gas of the EGR system according to the present embodiment. The introduction port 26 is formed in a wall surface of the intake passage 4, and the EGR passage 20 is connected to the introduction port 26. The EGR valve 25 which is a poppet valve is provided in the introduction port 26, and an opening area of the introduction port 26 changes by movement in an axial direction of the EGR valve 25, namely, lift of the poppet valve. In FIG. 7, a relation of a flow rate of fresh air flowing from an upstream side in the intake passage 4, a flow velocity of the EGR gas that flows out from the introduction port 26, and a travel direction in the intake passage 4 of water droplets contained in the EGR gas is expressed in a vector diagram. In FIG. 7, Gₐ represents the flow rate (mass flow rate) of fresh air, Vₐ represents a flow velocity of the fresh air, V_{egr} represents the flow velocity of the EGR gas, Vᵣ represents a velocity of the water droplets contained in the EGR gas, and aᵣ represents a travel angle of the water droplets contained in the EGR gas, respectively.

According to a configuration of the EGR system according to the present embodiment, the EGR gas flows out from the introduction port 26 perpendicularly to a flow of the fresh air as a result that the EGR valve 25, which is a poppet valve, opens. Therefore, as for the velocity of the EGR gas that flows out from the introduction port 26, an outflow angle is always 90 degrees and is constant, and only the flow velocity (a magnitude of velocity) changes. The flow velocity of the EGR gas that flows out from the introduction port 26 is determined by a volume flow rate of the EGR gas that flows out and an opening area of the introduction port 26. According to the configuration of the EGR system according to the present embodiment, the opening area of the introduction port 26 is a variable that is determined by an opening degree of the EGR valve 25, that is, the lift amount of the poppet valve. Meanwhile, the volume flow rate of the EGR gas is a variable that is determined by the opening degree of the EGR valve 25 and a pressure ratio across the EGR valve 25 in accordance with the flow rate characteristic shown in FIG. 4, and the pressure ratio across the EGR valve 25 is a variable that is determined by the opening degree of the exhaust throttle valve 8. Namely, in the EGR system according to the present embodiment, the flow velocity of the EGR gas that flows out from the introduction port 26 can be controlled based on the opening degree of the EGR valve 25 and the opening degree of the exhaust throttle valve 8.

In the EGR system according to the present embodiment, control of each of the EGR valve 25 and the exhaust throttle valve 8 is performed by the control device 30. FIG. 8 is a flowchart showing a routine that is executed by the control device 30 in the present embodiment. The routine is one of the control programs included in the control device 30. The control program stored in a memory of the control device 30 is read and executed by a processor, and thereby a function as a “control device” according to the present invention is given to the control device 30. Hereinafter, the routine will be sequentially described.

In step S11, the control device 30 compares the atmospheric temperature (Ta) with the condensed water generation temperature (Tcri) that is set in advance. When the atmospheric temperature is the condensed water generation temperature or higher, the control device 30 ends the present routine.

When the atmospheric temperature is lower than the condensed water generation temperature, the control device 30 executes processing of each of steps S12, S13, S14 and S15 in sequence.

In step S12, the control device 30 calculates the target flow velocity (target V_{egr}) of the EGR gas based on the flow rate (Gₐ) of fresh air that is measured by the airflow meter 6. The control device 30 has a map that makes the flow velocity of the EGR gas correspond to the flow rate of fresh air, and determines the target flow velocity of the EGR gas by using the map. In the map, the target flow velocity is set so that the EGR gas which flows out from the introduction port 26 flows toward the center portion of the impeller.

In step S13, the control device 30 calculates the target volume flow rate (target Q_{egr}) of the EGR gas. In the first embodiment, the opening areas of the introduction ports for the EGR gas are constant, and therefore, the target volume flow rate of the EGR gas can be calculated based on the target flow velocity of the EGR gas. However, in the present embodiment, the opening area of the introduction port 26 for the EGR gas changes in accordance with the opening degree of the EGR valve 25. Therefore, the target volume flow rate cannot be uniquely determined from the target flow velocity of the EGR gas. Therefore, in the present embodiment, a target EGR rate is used as a parameter for calculation of the target volume flow rate, and a value that is obtained by multiplying the flow rate of fresh air by the target EGR rate is used as the target volume flow rate of the EGR gas. The target EGR rate is an adaptation value that can ensure desired engine performance in the situation in which the atmospheric temperature is lower than the condensed water generation temperature. Note, however, the target EGR rate which is determined by EGR control that is executed by a routine different from the present routine may be used.

In step S14, the control device 30 determines the opening degree of the EGR valve 25 based on the target flow velocity of the EGR gas which is calculated in step S12, and the target volume flow rate of the EGR gas which is calculated in step S13. A value that is obtained by dividing the target volume flow rate by the target flow velocity corresponds to the opening area of the introduction port 26 that can achieve the target flow velocity under the target volume flow rate. The opening degree of the EGR valve 25 and the opening area of the introduction port 26 are in a one-to-one relationship, and therefore, if the opening area which is a target is determined, the opening degree of the EGR valve 25 is uniquely determined.

In step S15, the control device 30 determines the opening degree of the exhaust throttle valve 8 based on the target volume flow rate of the EGR gas which is calculated in step S13 and the opening degree of the EGR valve 25 which is calculated in step S14. According to the flow rate characteristic of the EGR valve, the pressure ratio across the EGR valve is uniquely determined if the volume flow rate of the EGR gas and the opening degree of the EGR valve are given. In the present embodiment, the pressure downstream of the EGR valve 25 can be regarded as equal to atmospheric pressure. Therefore, the target value of the pressure upstream of the EGR valve 25 is uniquely determined from the target volume flow rate and the opening degree of the EGR valve 25, and the opening degree of the exhaust throttle valve 8 for realizing the target value is uniquely determined.

By cooperatively controlling the EGR valve 25 and the exhaust throttle valve 8 in accordance with the above routine, the flow velocity of the EGR gas which flows out from the introduction port 26 is changed in accordance with the flow rate of fresh air, and the EGR gas containing condensed water can be caused to flow toward the center portion of the impeller. Further, according to the present embodiment, the EGR gas can be introduced in accordance with the target EGR rate.

### Third Embodiment

Next, a third embodiment of the present invention will be described with reference to the drawings.

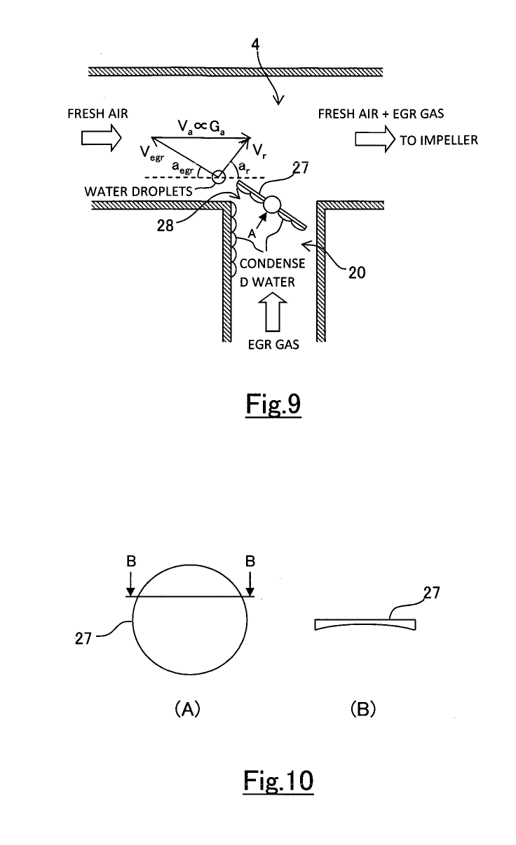

An EGR system according to the third embodiment of the present invention is also applied to the supercharging engine of the configuration shown in FIG. 6, similarly to the second embodiment. However, in the present embodiment, in place of the EGR valve 25 which is a poppet valve, an EGR valve 27 which is a butterfly valve is provided in the connecting portion of the EGR passage 20 and the intake passage 4, as shown in FIG. 9.

FIG. 9 is a sectional view showing a configuration of a vicinity of an introduction port 28 for EGR gas of an EGR system according to the present embodiment. The introduction port 28 is formed in a wall surface of the intake passage 4, and the EGR passage 20 is connected to the introduction port 28. The EGR valve 27 which is a butterfly valve is provided in the introduction port 28. In the EGR valve 27 which is a butterfly valve, a valve body thereof functions as a guide plate that fixes a flow direction of the EGR gas. Therefore, an opening area of the introduction port 28 changes in accordance with an opening angle of the EGR valve 27, and at the same time, an outflow direction of the EGR gas also changes in accordance with the opening angle of the EGR valve 27. In the present embodiment, the EGR valve 27 is provided to open by inclining to an upstream side in the flow direction of fresh air so that the EGR gas flows out to the upstream side in the flow direction of fresh air from the introduction port 28.

In FIG. 9, a relation of a flow rate of fresh air flowing from an upstream side in the intake passage 4, an outflow direction of the EGR gas that flows out from the introduction port 28, and a travel direction in the intake passage 4 of water droplets contained in the EGR gas is expressed in a vector diagram. In FIG. 9, Gₐ represents the flow rate (mass flow rate) of fresh air, Vₐ represents a flow velocity of the fresh air, V_{egr} represents the flow velocity of the EGR gas which flows out from the introduction port 28, a_{egr} represents an outflow angle of the EGR gas which flows out from the introduction port 28, Vᵣ represents a velocity of the water droplets contained in the EGR gas, and aᵣ represents a travel angle of the water droplets contained in the EGR gas, respectively.

According to a configuration of the EGR system according to the present embodiment, both a magnitude of a velocity (flow velocity) and an angle (outflow angle) of the EGR gas which flows out from the introduction port 28 change in accordance with the opening degree of the EGR valve 27 which is a butterfly valve. The velocity in the intake passage 4, of the water droplets contained in the EGR gas is determined by the flow velocity and the outflow angle of the EGR gas and the flow velocity of fresh air. Therefore, in order to cause the EGR gas containing condensed water to flow toward the center portion of the impeller, the flow velocity and the outflow angle of the EGR gas can be changed in accordance with the flow rate of the fresh air. According to the configuration of the EGR system according to the present embodiment, the flow velocity of the EGR gas which flows out from the introduction port 28 is determined by the volume flow rate of the EGR gas which flows out and the opening area of the introduction port 28. The volume flow rate of the EGR gas is a variable that is determined by the opening degree of the EGR valve 27 and the opening degree of the exhaust throttle valve 8. The opening area of the introduction port 28 is a variable that is determined by the opening degree of the EGR valve 27. Further, the outflow angle of the EGR gas is a variable that is also determined by the opening degree of the EGR valve 27. Therefore, in the EGR system according to the present embodiment, the flow velocity and the outflow angle of the EGR gas that flows out from the introduction port 28 can be controlled based on the opening degree of the EGR valve 27 and the opening degree of the exhaust throttle valve 8.

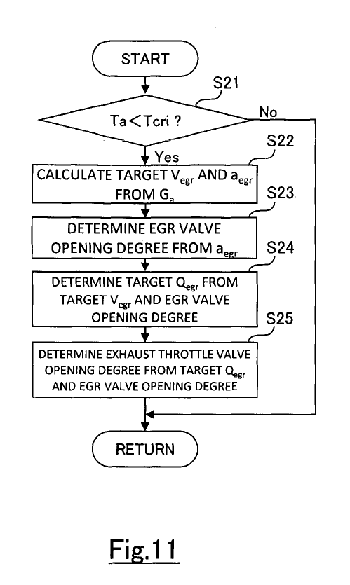

Note that the EGR valve 27 which is used in the present embodiment has a feature in a shape thereof. As shown in FIG. 10, a surface at a side of the EGR passage 20, of the EGR valve 27, namely, a surface at a side that hits the EGR gas which flows in the EGR passage 20 is a concave surface. This is to receive the condensed water generated in the EGR passage 20 with the concave surface of the EGR valve 27 to cause the condensed water to flow out into the intake passage 4 from a fixed position. By preventing the position at which the water droplets flow out from varying, the travel direction of the water droplets in the intake passage 4 can be stabilized.

In the EGR system according to the present embodiment, control of each of the EGR valve 27 and the exhaust throttle valve 8 is performed by the control device 30. FIG. 11 is a flowchart showing a routine that is executed by the control device 30 in the present embodiment. The routine is one of the control programs included in the control device 30. The control program stored in the memory of the control device 30 is read and executed by a processor, and thereby a function as a “control device” according to the present invention is given to the control device 30. Hereinafter, the routine will be sequentially described.

In step S21, the control device 30 compares the atmospheric temperature (Ta) with the condensed water generation temperature (Tcri) that is set in advance. When the atmospheric temperature is the condensed water generation temperature or higher, the control device 30 ends the present routine.

When the atmospheric temperature is lower than the condensed water generation temperature, the control device 30 executes processing of each of steps S22, S23, S24 and S25 in sequence.

In step S22, the control device 30 calculates the target flow velocity (target V_{egr}) and the outflow angle (a_{egr}) of the EGR gas based on the flow rate (Gₐ) of fresh air that is measured by the airflow meter 6. The control device 30 has a map that makes the flow velocity and the outflow angle of the EGR gas correspond to the flow rate of fresh air, and determines the target flow velocity and the outflow angle of the EGR gas by using the map. In the map, the target flow velocity and the outflow angle are set so that the EGR gas which flows out from the introduction port 28 flows toward the center portion of the impeller.

In step S23, the control device 30 determines the opening degree of the EGR valve 27 based on the target outflow angle of the EGR gas which is calculated in step S22. The opening degree of the EGR valve 27 and the outflow angle of the EGR gas are in a one-to-one relationship, and therefore, if the outflow angle to be a target is determined, the opening degree of the EGR valve 27 is uniquely determined.

In step S24, the control device 30 calculates the target volume flow rate (target Q_{egr}) of the EGR gas based on the target flow velocity of the EGR gas which is calculated in step S22, and the opening degree of the EGR valve 27 which is calculated in step S23. The opening degree of the EGR valve 27 and the opening area of the introduction port 28 are in a one-to-one relationship, and therefore, if the opening degree of the EGR valve 27 is determined, the opening area is uniquely determined. A value that is obtained by multiplying the target flow velocity of the EGR gas by the opening area of the introduction port 28 corresponds to the target volume flow rate for achieving the target flow velocity.

In step S25, the control device 30 determines the opening degree of the exhaust throttle valve 8 based on the target volume flow rate of the EGR gas which is calculated in step S24 and the opening degree of the EGR valve 27 which is calculated in step S23. According to the flow rate characteristic of the EGR valve, the pressure ratio across the EGR valve is uniquely determined if the volume flow rate of the EGR gas and the opening degree of the EGR valve are given. In the present embodiment, the pressure downstream of the EGR valve 27 can be regarded as equal to atmospheric pressure. Therefore, the target value of the pressure upstream of the EGR valve 27 is uniquely determined from the target volume flow rate and the opening degree of the EGR valve 27, and the opening degree of the exhaust throttle valve 8 for realizing the target value is uniquely determined.

By cooperatively controlling the EGR valve 27 and the exhaust throttle valve 8 in accordance with the above routine, the velocity, namely, the flow velocity and the outflow angle of the EGR gas which flows out from the introduction port 28 are changed in accordance with the flow rate of fresh air, and the EGR gas containing condensed water can be caused to flow toward the center portion of the impeller.

### Others

The present invention is not limited to the aforementioned embodiments, and can be carried out by being variously modified within the range without departing from the gist of the present invention. For example, while in the first and the second embodiments, the introduction ports for EGR gas are formed so that the EGR gas flows out perpendicularly to the flow of fresh air, the introduction ports may be formed so that the EGR gas flows out with predetermined outflow angles. Further, while in each of the aforementioned embodiments, the flow rate of fresh air is measured with the airflow meter, and the measured value is used, the flow rate of fresh air may be estimated from the load of the engine and the engine speed, and the estimated value may be used. Further, while in each of the aforementioned embodiments, generation of the condensed water is determined from an atmospheric temperature, generation of the condensed water may be determined from a cooling water temperature in place of an atmospheric temperature, or may be determined from the atmospheric temperature and the cooling water temperature.

### REFERENCE SIGNS LIST

1 Engine main body
2 Intake manifold
3 Exhaust manifold
4 Intake passage
5 Exhaust passage
6 Airflow meter
7 Catalyst
8 Exhaust throttle valve
10 Supercharger
11 Compressor
12 Turbine
20 EGR passage
21 EGR cooler
22 Mixer
23, 25, 27 EGR valve
24, 26, 28 Introduction port
30 Control device

1. An EGR system for a supercharging engine, comprising:
an introduction port for an EGR gas that is formed in a wall surface of an intake passage in a vicinity of an inlet of a compressor;
an EGR passage that connects the introduction port to an exhaust passage;
an EGR valve that is provided in the EGR passage;
an exhaust throttle valve that is provided downstream of a position where the EGR passage is connected in the exhaust passage; and
a control device that controls the EGR valve and the exhaust throttle valve,
wherein the control device includes a control program for changing a velocity of the EGR gas that flows out into the intake passage from the introduction port in accordance with a flow rate of fresh air that flows to the compressor so that the EGR gas flows toward a center portion of an impeller of the compressor, and
the control program is configured to control respective opening degrees of the EGR valve and the exhaust throttle valve in accordance with the flow rate of the fresh air that flows to the compressor.

2. The EGR system for a supercharging engine according to claim 1,
wherein the EGR valve is provided at a position apart from the introduction port, and
the control program comprises
a step of calculating a target flow velocity of the EGR gas based on a measured value or an estimated value of the flow rate of the fresh air that flows to the compressor,
a step of calculating a target volume flow rate of the EGR gas based on the target flow velocity; and
a step of determining respective opening degrees of the EGR valve and the exhaust throttle valve based on the target volume flow rate.

3. The EGR system for a supercharging engine according to claim 1,
wherein the EGR valve is a valve that is provided in the introduction port and makes an introduction port area variable, and
the control program comprises
a step of calculating a target flow velocity of the EGR gas based on a measured value or an estimated value of the flow rate of the fresh air that flows to the compressor,
a step of calculating a target volume flow rate of the EGR gas based on the measured value or the estimated value, and a target EGR rate,
a step of determining the opening degree of the EGR valve based on the target flow velocity and the target volume flow rate, and
a step of determining the opening degree of the exhaust throttle valve based on the opening degree of the EGR valve and the target volume flow rate.

4. The EGR system for a supercharging engine according to claim 1,
wherein the EGR valve is a butterfly valve provided in the introduction port, and the control program comprises
a step of calculating a target flow velocity and a target outflow angle of the EGR gas based on a measured value or an estimated value of the flow rate of the fresh air that flows to the compressor,
a step of determining the opening degree of the EGR valve based on the target outflow angle,
a step of calculating a target volume flow rate of the EGR gas based on the target flow velocity and the opening degree of the EGR valve, and
a step of determining the opening degree of the exhaust throttle valve based on the opening degree of the EGR valve and the target volume flow rate.

5. The EGR system for a supercharging engine according to claim 4,
wherein a surface at a side of the EGR passage, of the butterfly valve is a concave surface.

6. The EGR system for a supercharging engine according to claim 3,
wherein the EGR valve is a poppet valve with a variable lift amount, and the introduction port area changes in accordance with the lift amount.
